(19) United States
(12) Patent Application Publication
(10) Pub. No.: US 2012/0036425 A1
(43) Pub. Date: Feb. 9, 2012

(54) INFORMATION PROCESSING APPARATUS, INFORMATION PROCESSING SYSTEM, CONTROL METHOD FOR THE INFORMATION PROCESSING APPARATUS, AND RECORDING MEDIUM

(75) Inventor: Tetsuya Sato, Yokohama-shi (JP)

(73) Assignee: CANON KABUSHIKI KAISHA, Tokyo (JP)

(21) Appl. No.: 13/185,584

(22) Filed: Jul. 19, 2011

(30) Foreign Application Priority Data
Aug. 9, 2010 (JP) 2010-179001

(51) Int. Cl. G06F 17/00

(52) U.S. Cl. 715/234

(57) ABSTRACT

An information processing apparatus according to this invention, if a user instructs execution of a function of the information processing apparatus via a first operation screen displayed in a display unit by a Web browser based on screen information provided by a Web server, generates a script including a preset execution condition for executing the function and then transmits the generated script to the Web server. Further, upon acceptance of a modification of the execution condition by the user via a second operation screen displayed based on the screen information received from the Web server, the information processing apparatus receives, from the Web server, the script that has been edited by the Web server in accordance with the modified execution condition, and executes the function in accordance with the edited script.

### BACKGROUND OF THE INVENTION

1. Field of the Invention

The present invention relates to an information processing apparatus, an information processing system including a Web server and the information processing apparatus, a control method for the information processing apparatus, and a recording medium.

2. Description of the Related Art

It is known that an information processing apparatus such as a PC is connected to a Web server on a network and an operation screen based on screen information provided by the Web server is displayed in a display unit by a Web browser of the information processing apparatus. In this case, first, the Web browser of the information processing apparatus requests the operation screen from the Web server. In response to the request from the information processing apparatus, a Web application on the Web server generates an HTML file (screen information) for displaying the operation screen in the display unit by the Web browser, and transmits the HTML file to the information processing apparatus as a response. The Web browser of the information processing apparatus analyzes the received HTML file and displays the operation screen based on the descriptions in the HTML file in the display unit. Furthermore, upon acceptance of an instruction input by the user via the displayed operation screen, the Web browser notifies the Web server of the input instruction. Upon receipt of this notification, the Web application on the Web server executes processing in the information processing apparatus in accordance with the input instruction.

Recently, some Multi Function Peripherals (MFPs) including a scanner, a printer and so forth have also included a Web browser as described above. Such an MFP uses the above-described procedure to display, by the Web browser, an operation screen based on screen information provided by the Web server, and accepts various instructions from the user via the operation screen. This configuration allows the Web server to control the customization of the operation screen of the MFP and the use of the functions of the MFP, and thus facilitates implementation of a variety of systems utilizing the functions of the MFP. There is demand for vendors developing MFPs to release functions of an MFP so as to be used in a user-friendly manner.

Furthermore, according to Japanese Patent Laid-Open No. 2006-129356, a Web application acquires function information of an MFP from the MFP. Also, based on the result of analysis of the function information, the Web application generates screen information about an operation screen for using various functions of the MFP and provides the MFP with the screen information. When the user instructs the establishment of a connection to the Web application, the Web browser of the MFP first transmits the function information to the Web application together with a connection request. The Web application analyzes the received function information and transmits the screen information about the operation screen corresponding to the function information to the MFP. The Web browser of the MFP displays the operation screen based on the received screen information and accepts an instruction input by the user via the operation screen. Then, the Web browser notifies the Web application of the input instruction as a request. Upon receipt of this notification, the Web application generates a script in which various processes to be executed in the MFP are described, in accordance with the input instruction. The Web application notifies the MFP of the generated script as a response to the request from the Web browser. The Web browser of the MFP passes the received script to a script processing unit, thereby causing the script processing unit to execute the script. In this way, the user uses the functions of the MFP.

However, according to Japanese Patent Laid-Open No. 2006-129356, the Web application of the Web server has to implement the function of generating, from scratch, a script in which various processes to be executed in the information processing apparatus are described, even when the setting of only some of the functions of the information processing apparatus (MFP) is controlled. Moreover, when the functions of the information processing apparatus are enhanced with a version upgrade or the like, the script generation function of the Web application also needs to be modified in conformity with the functionality enhancement.

### SUMMARY OF THE INVENTION

The present invention has been achieved in view of the foregoing problem and provides a mechanism that can reduce the burden of development of a Web application by generating a script corresponding to a function of an information processing apparatus and transmitting the script to a Web server.

According to one aspect of the present invention, there is provided an information processing apparatus comprising a Web browser that displays an operation screen based on screen information provided by a Web server, the apparatus comprising: a generation unit that, if a user instructs execution of a function of the information processing apparatus via a first operation screen displayed in a display unit of the information processing apparatus by the Web browser, generates a script including a preset execution condition for executing the function; a request unit that transmits the script generated by the generation unit to the Web server, and requests, from the Web server, screen information about a second operation screen for accepting a modification of the execution condition by the user; a transmission unit that, upon acceptance of the modification of the execution condition by the user via the second operation screen displayed based on the screen information received from the Web server in response to the request made by the request unit, transmits the modified execution condition to the Web server; and an execution unit that receives the script that has been edited by the Web server in accordance with the modified execution condition from the Web server, and executes the function in accordance with the edited script.

According to another aspect of the present invention, there is provided an information processing system comprising a Web server and an information processing apparatus comprising a Web browser that displays an operation screen based on screen information provided by the Web server, wherein the information processing apparatus comprises: a generation unit that, if a user instructs execution of a function of the information processing apparatus via a first operation screen displayed in a display unit of the information processing apparatus by the Web browser, generates a script including a preset execution condition for executing the function; a request unit that transmits the script generated by the generation unit to the Web server, and requests, from the Web server, screen information about a second operation screen for accepting a modification of the execution condition by the user; a transmission unit that, upon acceptance of the modification of the execution condition by the user via the second operation screen displayed based on the screen information received from the Web server in response to the request made by the request unit, transmits the modified execution condition to the Web server; and an execution unit that receives the script that has been edited by the Web server in accordance with the modified execution condition from the Web server, and executes the function in accordance with the edited script.

According to still another aspect of the present invention, there is provided a control method for an information processing apparatus comprising a Web browser that displays an operation screen based on screen information provided by a Web server, the method comprising: generating, if a user instructs execution of a function of the information processing apparatus via a first operation screen displayed in a display unit of the information processing apparatus by the Web browser, a script including a preset execution condition for executing the function; transmitting the script generated in the generation step to the Web server, and requesting, from the Web server, screen information about a second operation screen for accepting a modification of the execution condition by the user; transmitting, upon acceptance of the modification of the execution condition by the user via the second operation screen displayed based on the screen information received from the Web server in response to the request made in the request step, the modified execution condition to the Web server; and receiving the script that has been edited by the Web server in accordance with the modified execution condition from the Web server, and executing the function in accordance with the edited script.

According to yet another aspect of the present invention, there is provided a computer-readable recording medium storing a program for causing a computer to, in an information processing apparatus comprising a Web browser that displays an operation screen based on screen information provided by a Web server, function as: a generation unit that, if a user instructs execution of a function of the information processing apparatus via a first operation screen displayed in a display unit of the information processing apparatus by the Web browser, generates a script including a preset execution condition for executing the function; a request unit that transmits the script generated by the generation unit to the Web server, and requests, from the Web server, screen information about a second operation screen for accepting a modification of the execution condition by the user; a transmission unit that, upon acceptance of the modification of the execution condition by the user via the second operation screen displayed based on the screen information received from the Web server in response to the request made by the request unit, transmits the modified execution condition to the Web server; and an execution unit that receives the script that has been edited by the Web server in accordance with the modified execution condition from the Web server, and executes the function in accordance with the edited script.

According to the present invention, it is possible to provide a mechanism that can reduce the burden of development of a Web application by generating a script corresponding to a function of an information processing apparatus and transmitting the script to a Web server.

Further features of the present invention will become apparent from the following description of exemplary embodiments (with reference to the attached drawings).

### BRIEF DESCRIPTION OF THE DRAWINGS

FIG. 1 is a diagram showing an overall configuration of an information processing system according to an embodiment of the present invention.

FIGS. 2A and 2B are diagrams showing hardware configurations of an MFP and a Web server, respectively.

FIGS. 3A and 3B are diagrams showing software configurations of the MFP and the Web server, respectively.

FIGS. 4A and 4B show examples of function information managed by the MFP.

FIG. 5 is a sequence diagram of a communication process.

FIG. 6 shows an example a menu UI generated by the Web browser.

FIGS. 7A and 7B show examples of a script generated by the MFP.

FIG. 8 shows an example of script information managed by the Web server.

FIG. 9 is a flowchart illustrating a setting UI generation process.

FIGS. 10A and 10B show examples of a setting UI generated by the Web browser.

FIG. 11 is a flowchart illustrating script editing.

FIGS. 12A and 12B show examples of an edited script.

### DESCRIPTION OF THE EMBODIMENTS

Hereinafter, an embodiment of the present invention will be described in detail with reference to the accompanying drawings. It should be noted that the following embodiment is not intended to limit the scope of the claims and not all of the combinations of the features described in the embodiment are necessarily essential to the solving means of the present invention.

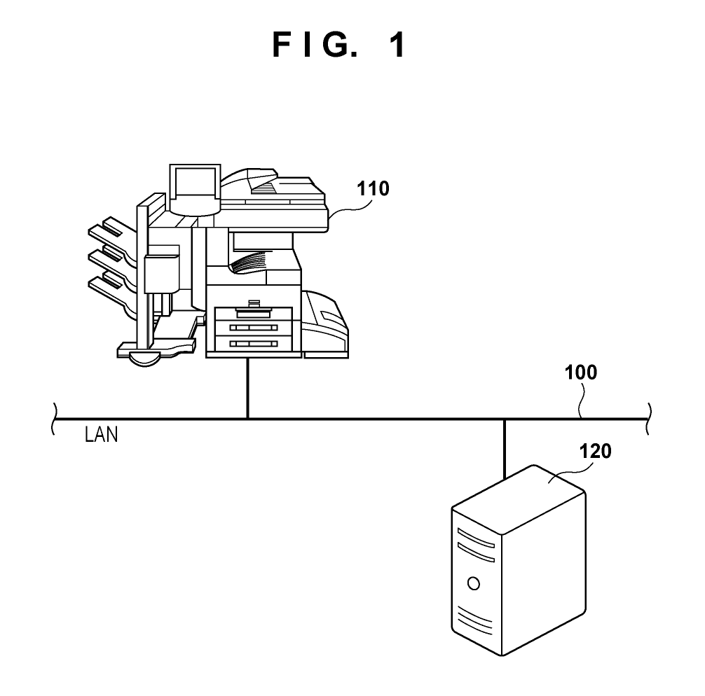

In this embodiment, a description is given of an example in which an MFP serving as an example of an information processing apparatus of the present invention executes image processing and image formation processing in accordance with an instruction from a Web server.

<Overall Configuration of Information Processing System (FIG. 1)>

An information processing system according to this embodiment includes a Web server 120 and an MFP 110 (information processing apparatus) including a Web browser that displays an operation screen provided by the Web server 120. The MFP 110 and the Web server 120 are each connected to a LAN 100 composed of Ethernet (registered trademark) or the like. The MFP 110 has a scan function, a file transfer function and an e-mail function. The file transfer function reads a document image and transfers image data (also referred to as “document data”) obtained by reading the image to a designated apparatus on the LAN 100 using the FTP protocol, the SMB protocol or the like. The e-mail function creates an e-mail containing the image data as an attached file and transmits the e-mail by using an e-mail server (not shown).

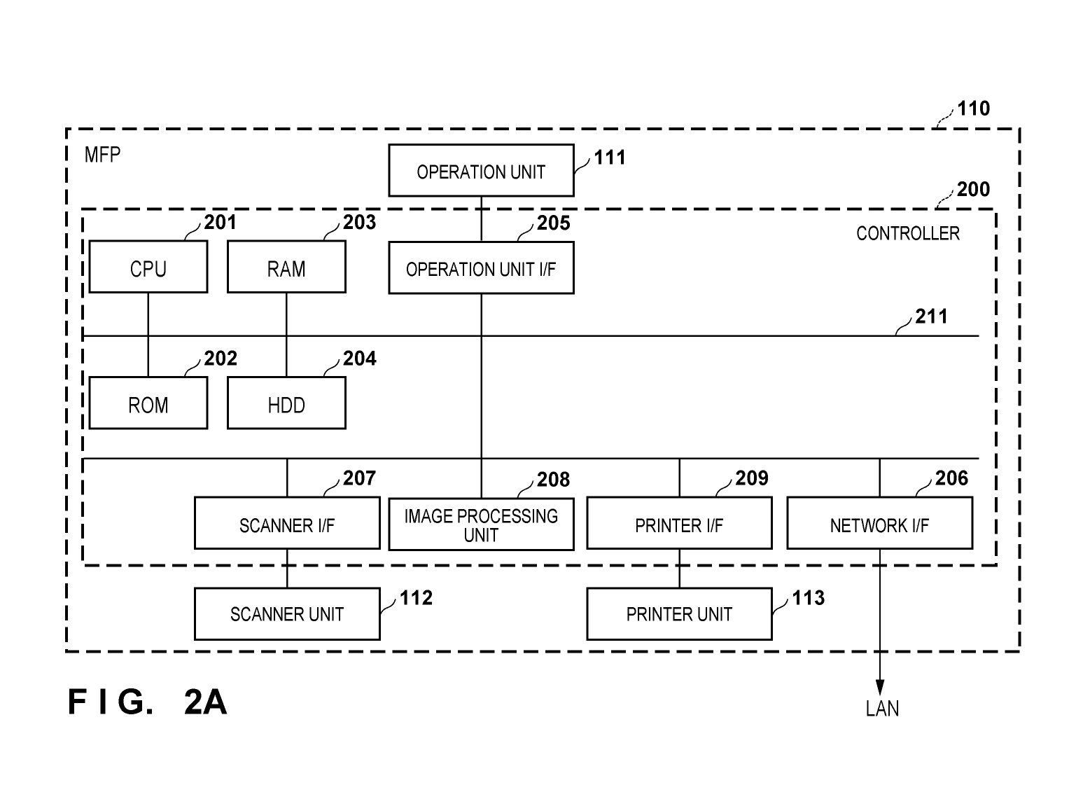

The Web server 120 includes a Web application, which is software that runs on the Web server. In response to a request from the MFP 110, the Web application transmits the HTML data corresponding to screen information for displaying a screen in an operation unit (display unit) of the MFP 110, to the MFP 110 as a response to that request. However, the number of these components of the information processing system according to this embodiment is not limited to the number of the components shown in FIG. 1. Although LAN is used as the method for connecting these components in this embodiment, the present invention is not limited thereto. For example, it is possible to use any network equivalent to a public network, such as Wide Area Network (WAN), a serial transmission scheme such as USB, or a parallel transmission scheme such as Centronics or SCSI.

<Hardware Configuration of MFP 110 (FIG. 2A)>

The MFP 110 includes a scanner unit 112 serving as a device for inputting images, a printer unit 113 serving as a device for outputting images, a controller 200 that provides overall control for the MFP 110, and an operation unit 111.

The scanner unit 112 is a device that reads an image on a document and generates image data. When a document is placed in a document feeder and an instruction to read the document is then given to the scanner unit 112 from the controller 200, the scanner unit 112 reads the document while feeding sheets of the document one by one from the document feeder. Note that the method for reading the document may be a method in which the document scan is performed by moving an exposure unit along a glass surface (not shown) with a document placed on the glass surface, instead of automating feeding using a document feeder. The printer unit 113 is an image formation device that forms an image corresponding to the image data received from the controller 200 on a sheet of paper. Note that an electrophotographic method using a photosensitive drum and a photosensitive belt can be used as the image formation method in this embodiment, and it is also possible to use an inkjet method or the like.

The controller 200 is electrically connected to the operation unit 111, the scanner unit 112 and the printer unit 113 via an operation unit interface (I/F) 205, a scanner I/F 207 and a printer I/F 209, respectively, and is also connected to the LAN 100 via a network I/F 206. That is, the controller 200 is connected to other devices via the LAN 100. This enables the controller 200 to communicate with the other devices using the HTTP protocol.

The CPU 201 provides overall control for accesses to various devices and accesses from other devices by loading a program such as a control program from the HDD 204 onto the RAM 203 and executing the program. At the same time, the CPU 201 provides overall control for various processes performed within the controller 200. This control includes execution of a program for implementing processing in accordance with a flowchart described below.

The ROM 202 stores a boot program of the apparatus. The RAM 203 functions as a system work memory for the CPU 201 to operate and also as a memory for temporarily storing image data. The RAM 203 is made up of an area that keeps holding the stored content, for example, by backup power after the power-off of the apparatus and an area in which the stored content is erased after the power-off. The hard disc drive (HDD) 204 can store system software and image data.

The operation unit I/F 205 is an interface for connecting the system bus 211 and the operation unit 111. The operation unit I/F 205 receives image data for being displayed in the operation unit 111 from the system bus 211, outputs the image data to the operation unit 111, and outputs the information input from the operation unit 111 to the system bus 211. The network I/F 206 is connected to the LAN 100 and the system bus 211, and enables input/output of information between the LAN 100 and the system bus 211. The scanner I/F 207 corrects, processes and edits the image data received from the scanner unit 112. Note that the scanner I/F 207 has the function of determining whether the received image data is based on, for example, a color document, a black and white document, a text document, or a picture document.

The image processing unit 208 executes image processing such as changing orientation of image data and an image compression/decompression process. Further, the image processing unit 208 can generate a single image by combining a plurality of images saved in the HDD 204. The printer I/F 209 receives the image data sent from the image processing unit 208 and performs image processing on the image data with reference to the attribute data added to the image data. The image processing unit 208 outputs the image data that has been subjected to the image processing to the printer unit 113.

Although a network MFP that executes the UI display is considered as an example of the information processing apparatus in this embodiment, the information processing apparatus may be a general-purpose computer to which a general-purpose scanner, a general-purpose printer and the like are connected, or a similar apparatus.

<Hardware Configuration of Web Server 120 (FIG. 2B)>

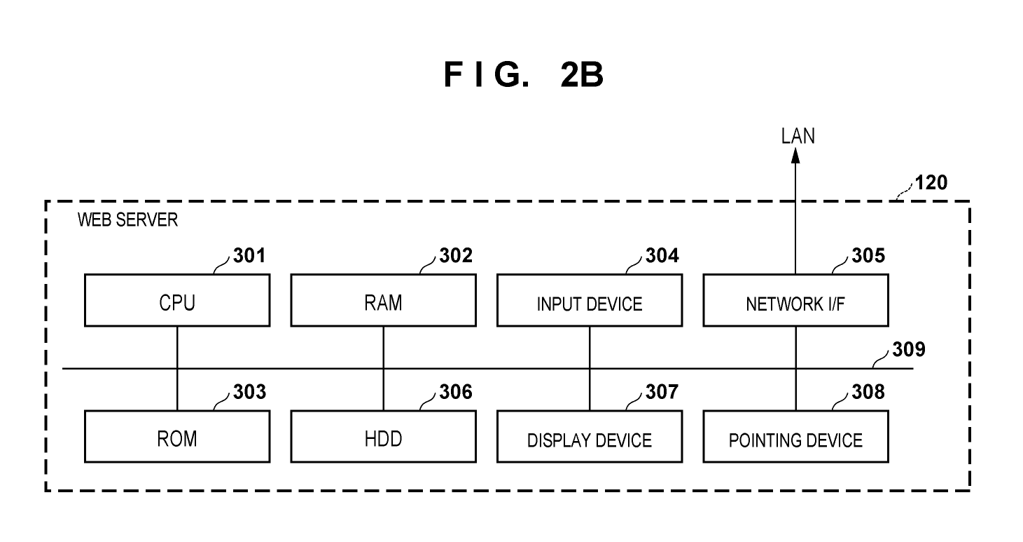

The Web server 120 includes a CPU 301, a RAM 302, a ROM 303, a network I/F 305, a HDD 306, a display device 307 such as a CRT, an input device 304 such as a keyboard, and a pointing device 308 such as a mouse. These devices are connected in such a manner that they can communicate with each other via a system bus 309. The ROM 303 or the HDD 306 stores a control program such as an operating system or a Web application. The CPU 301 fulfills the function of a computer by reading the control program from the ROM 303 or the HDD 306 onto the RAM 302 as needed and executing the program. Also, the CPU 301 displays various kinds of information via the display device 307 and accepts inputs such as a user instruction through the input device 304 and the pointing device 308. Further, the CPU 301 communicates with the other devices on the LAN 110 via the network I/F 305.

<Software Configuration of MFP 110 (FIG. 3A)>

The software modules of the MFP 110 are stored in the HDD 204 of the MFP 110, and the CPU 201 reads the software modules from the HDD 204 onto the RAM 203 as needed and executes the modules. An HTTP communication unit 401 is a software module that performs communication using the HTTP protocol by operating the network I/F 206. A Web browser 402 communicates with the Web server 120 via the HTTP communication unit 401. The Web browser 402 requests screen information about an operation screen described in HTML from the Web server 120 via the HTTP communication unit 401. Further, the Web browser 402 renders the HTML data about the operation screen (screen information) received from the Web server 120 via the HTTP communication unit 401 and displays the resulting data in the operation unit 111. When an input is made to the operation screen displayed in the operation unit 111, the Web browser 402 notifies the Web server 120 of the information input from the operation unit 111.

A script execution unit 403 receives, via the Web browser 402, a script that has been transmitted from the Web server 120 and parses the script, and divides the information contained in the script into pieces of job information. The script execution unit 403 gives a notification to a job management unit 404 so as to execute the pieces of job information obtained from the script, in the order specified in the script. The job management unit 404 manages the job information in response to an instruction from the script execution unit 403 and instructs a job execution unit 405 to sequentially execute the jobs. The job execution unit 405 is a module that executes processes in accordance with the job information. For example, when a job to be executed is a scan job, the job execution unit 405 reads a paper document by operating the scanner unit 112 and saves the resulting image data in the HDD 204. When a job to be executed is a transmission job, the job execution unit 405 transmits the image data contained in the HDD 204 by operating the network I/F 236. A script generation unit 406 is a module that generates job definition information (script) for executing the device functionality of the MFP 110. The script generation unit 406 acquires, from a function information management unit 407, currently available function information (execution condition) composed of a plurality of items, and generates a script according to the available function. Although the script generation unit 406 and the Web browser 402 are separated in this embodiment, the Web browser 402 may include the script generation unit 406.

The function information management unit 407 is a module that identifies any available function among the functions of the MFP based on the device configuration information and the user settings, and manages the function information relating to the identified function. Here, the device configuration information refers to hardware options such as a monochrome scanner and a color scanner and software options. Even among the MFPs of the same type, the available function may vary depending on the hardware options or the software options. The user settings refer to the settings, specific to each MFP, that are established by the administrator. For example, settings such as mandatory signature for security purposes or the like can be established for some MFPs. “Mandatory signature” refers to the setting specifying that image data is always required to be signed when transmitted in a PDF format. Thus, the available function of MFPs may also vary depending on the difference in the user settings.

The information managed by the function information management unit 407 may also vary depending on the version of MFPs. For example, the magnification of images to be scanned can be set for a new MFP, whereas the magnification cannot be set for an old MFP. In that case, an error may occur if a script in which the magnification is specified is executed by the old MFP. Conversely, if a script in which the magnification is not specified is executed by the new MFP, an error may occur because no magnification is specified. Thus, the available function may also vary with different versions of MFPs. The information managed by the function information management unit 407 will be described later.

<Software Configuration of Web Server 120 (FIG. 3B)>

The Web server 120 includes a Web application 501 and an HTTP communication unit 504 as software modules. The Web application 501 contains a presentation unit 502 and a logic unit 503. These software modules are stored in the HDD 306 of the Web server 120, and the CPU 301 reads the software modules from the HDD 306 onto the RAM 302 as needed and executes the modules.

In response to a request from the MFP 110, the presentation unit 502 transmits, to the MFP 110 via the HTTP communication unit 504, the screen information about the operation screen to be displayed in the operation unit 111 by the Web browser 402 of the MFP 110 as a response to the request. Further, the presentation unit 502 receives, from the MFP 110 via the HTTP communication unit 504, the input information from the user that has been input via the operation screen displayed in the operation unit 111 by the Web browser 402 of the MFP 110.

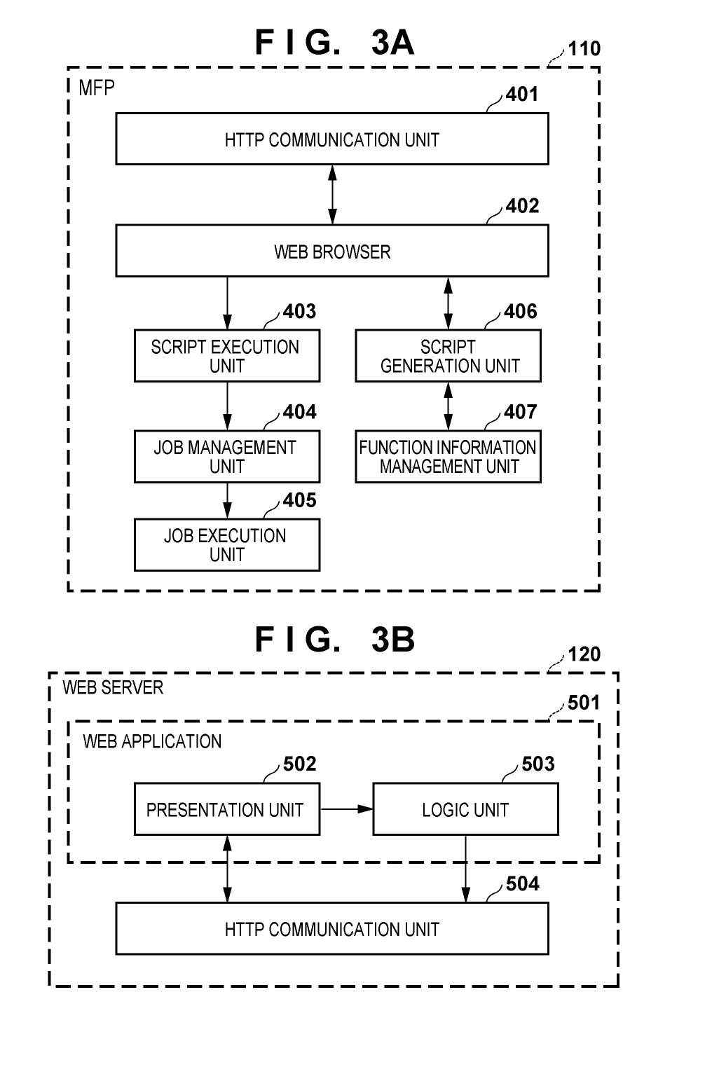

The logic unit 503 performs processes in accordance with the input information from the MFP 110 that has been passed from the presentation unit 502. For example, the logic unit 503 modifies the screen to be displayed and edits job definition information (script) for performing the device functionality of the MFP 110, according to the input from the user. The HTTP communication unit 504 is a software module that performs communication using the HTTP protocol by operating the network I/F 305.

<Function Information of MFP 110 (FIGS. 4A and 4B)>

The function information management unit 407 of the MFP 110 manages a data table indicating the function information. Although the function information is managed using a table form in this embodiment, it is possible to use a CSV (Comma Separated Values) form or a text file in XML (Extensible Markup Language) or the like.

First, an example of the function information will be described with reference to FIG. 4A. Function information 600 is made up of columns 601 to 605. The column 601 indicates the job to which each setting item in the column 602 relates. For example, referring to the first row, it can be seen that the setting item relates to “scan job”. The column 602 indicates setting items. For example, referring to the first row, it can be seen that the setting item is “color mode”. The column 603 indicates initial values. For example, referring to the first row, it can be seen that the initial value of the color mode setting is “full color”. The column 604 indicates the settable ranges of the setting items in the column 602 for the jobs in the column 601. For example, referring to the first row, it can be seen that “full color” and “gray scale” can be set as the color mode. The column 605 indicates whether the setting can be modified from the initial value. For example, referring to the first row, it can be seen that the setting is modifiable because “true” is indicated.

Next, another example of the function information will be described with reference to FIG. 4B. The components of the columns contained in function information 650 in FIG. 4B are the same as the components in FIG. 4A. However, FIG. 4B is different from FIG. 4A with respect to the device configuration information and the user settings of the MFP 110. For a better understanding of the effects of the present embodiment, the following description will be basically given of the case where the function information of the MFP 110 is the function information 600 shown in FIG. 4A. Where necessary, a description will also be given of the case where the function information of the MFP 110 is the function information 650 shown in FIG. 4B. The function information 650 is made up of columns 651 to 655, and the components are the same as those of the function information 600. For example, referring to the third line, it can be seen that the initial value of the file format, which is the setting item relating to the transmission job, is “signed PDF”. Also, the settable range of the setting item in the column 652 for the job in the column 651 includes “signed PDF”, “PDF” and “JPEG”, but it can be seen that the setting cannot be modified from the initial value in the column 653 (“false” in the column 655).

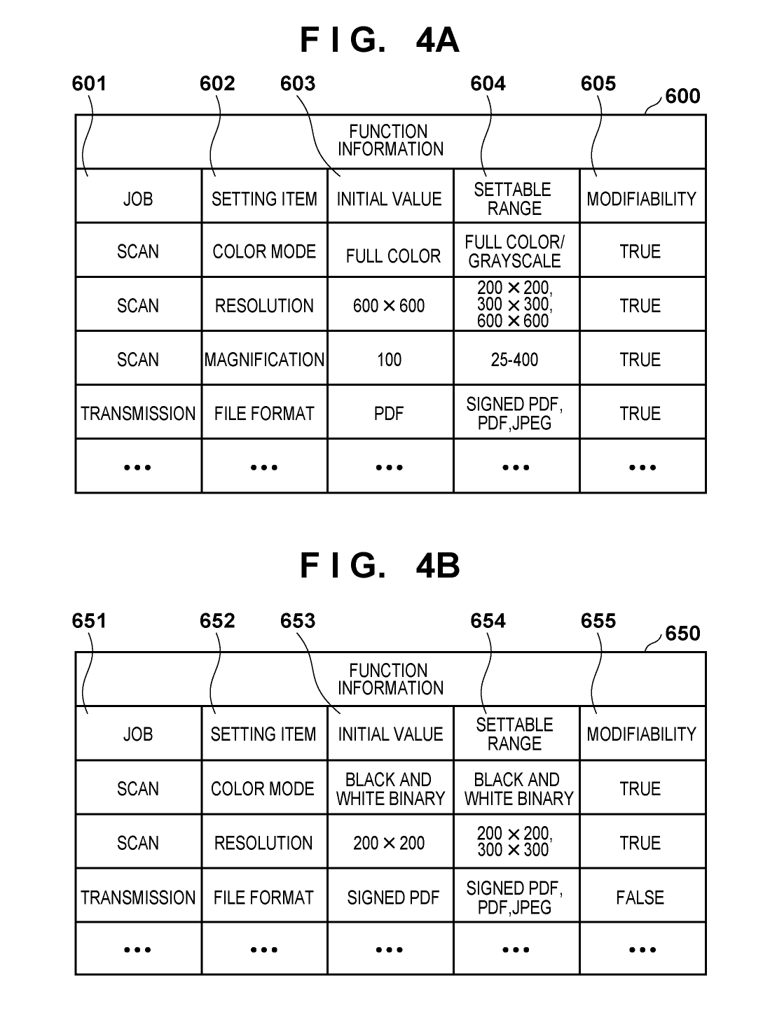

A comparison between FIG. 4A and FIG. 4B shows that the function information 600 includes the magnification as a setting item, but the function information 650 does not include the magnification as a setting item. This indicates that the magnification cannot be set for the MFP corresponding to the function information 650 because it is older than the MFP corresponding to the function information 600. That is, a magnification specification needs to be described in a script in a state where the function information of the MFP 110 is the function information 600, whereas a magnification specification does not need to be described in a script in a state where the function information of the MFP 110 is the function information 650. The function information 600 and 650 shown in FIGS. 4A and 4B are updated each time the device configuration information and the user settings described above are modified.

<Job Execution Flow (FIG. 5)>

Here, a description will be given of a scan transmission process as an example of the processes executed in the information processing system according to this embodiment. The scan transmission process is a process of reading a paper document on a document platen by the scanner 112 of the MFP 110 to generate image data and transferring a file containing the generated image data to an FTP server (not shown) on the LAN 100. First, the Web browser 402 is started by the user depressing a hardware button (not shown) provided in the operation unit 111 of the MFP 110 for executing the file transfer function.

To acquire a menu screen (first operation screen) for executing the processes corresponding to the functions of the MFP 110, the Web browser 402 transmits a request for the menu screen to the Web application 501 on the Web server 120 (S101). In this embodiment, it is assumed that the MFP 110 has been previously set to transmit the request using the URL indicating the location of the content of the menu screen at the start of the Web browser 402. Here, the Web browser 402 transmits a request through an HTTP GET command to the Web application 501 holding the content corresponding to the aforementioned URL (S101). Specifically, when the Web browser 402 passes the URL to the HTTP communication unit 401, the HTTP communication unit 401 communicates with the HTTP communication unit 504 of the Web server 120 using the HTTP protocol. In accordance with the received URL, the HTTP communication unit 504 notifies the Web application 501 that an appropriate request has been made. Consequently, a request for the menu screen is made from the Web browser 402 to the Web application 501. Note that the operations of the HTTP communication unit 401 and the HTTP communication unit 504 are omitted in the following description.

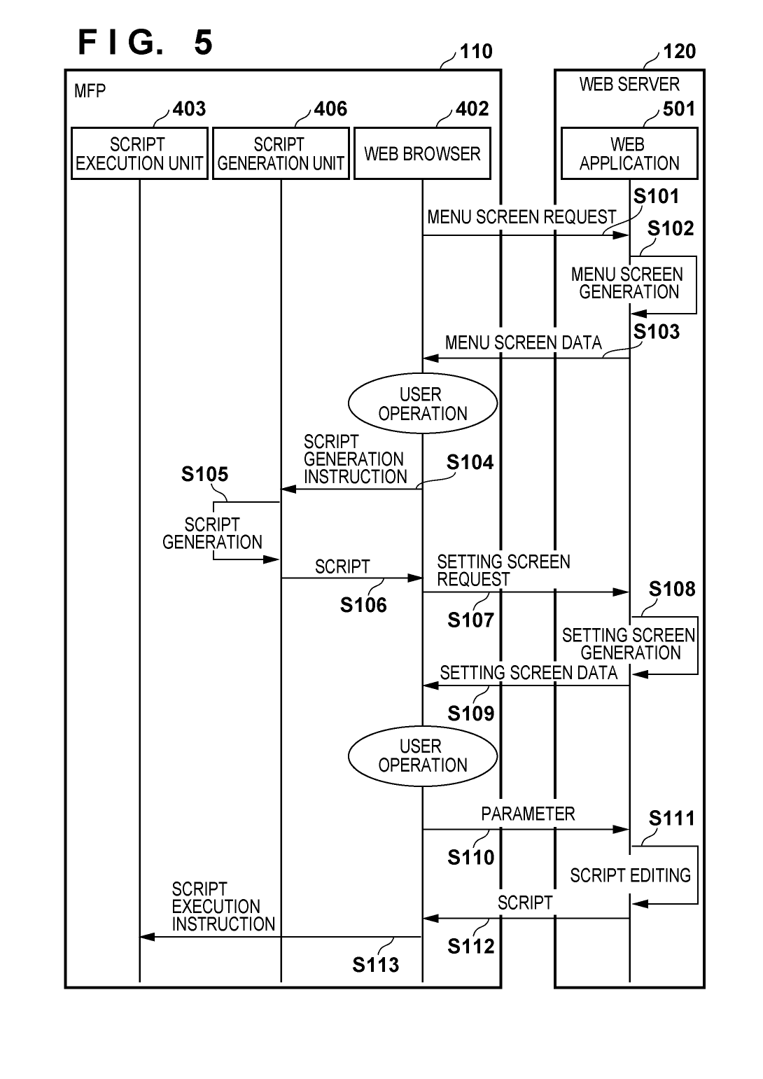

In response to the request made in S101, the presentation unit 502 of the Web application 501 generates HTML data (screen information) about the menu screen (S102), and transmits the generated HTML data to the Web browser 402 as an HTTP response (S103). The Web browser 402 analyzes the received HTML data and displays the menu screen based on the HTML data in the operation unit 111. An example of the menu screen is shown in FIG. 6. In FIG. 6, a GUI panel 800 displayed in the operation unit 111 displays a button 801. The button 801 is used for instructing execution of a scan transmission process of performing FTP transmission of data obtained by scanning a document.

When the button 801 is depressed by the user, the Web browser 402 instructs the script generation unit 406 to generate a script for executing the scan transmission process (S104). Upon receipt of the generation instruction, the script generation unit 406 generates a script based on the state of the MFP 110 (S105). At this time, the script generation unit 406 acquires, from the function information management unit 407, the information relating to the scan job and the transmission job included in the function information 600. The script generation unit 406 generates a script based on the acquired information. Specifically, the script generation unit 406 generates a script by using the initial values described in the column 603 as the set values of the setting items (column 602) for “scan job” and “transmission job” (column 601). Further, the script generation unit 406 includes in the script the modifiability information described in the column 605.

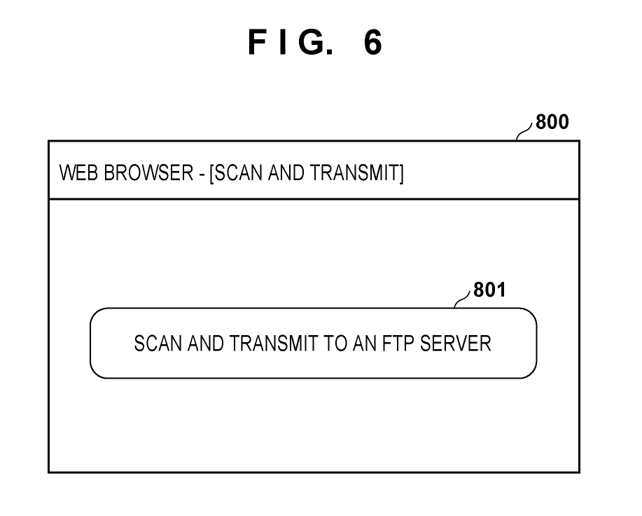

Here, a description will be given of an example of a script generated by the script generation unit 406 in S105, with reference to FIGS. 7A and 7B. In the following, a description will be each given of a script 900 (FIG. 7A) that is generated in the case where the function information managed by the function information management unit 407 is the function information 600 (FIG. 4A) and a script 950 (FIG. 7B) that is generated in the case where the function information managed by the function information management unit 407 is the function information 650 (FIG. 4B).

The script 900 that is generated in the case where the function information management unit 407 manages the function information 600 is a script for executing the scan job and the transmission job in order. Here, the script 900 is expressed in XML, but the script 900 may be in any format as long as the format can be processed by the MFP 110. A tag 901 is a “JobScript” tag, indicating that the job sequence indicated in that tag is executed. Here, a “Scan” tag 902 and a “Send” tag 908 are contained in the “JobScript” tag 901, and these processes are executed.

A “Scan” tag 902 is setting information about the scan job executed in a scripting process. A “Settings” tag 903 indicates that a job setting follows this tag. A “DocumentSize” tag 904 indicates that the size of the document to be scanned should be automatically determined (“Auto”) in the scanner unit 203. A “ColorMode” tag 905 indicates that the color mode is full color mode (“FullColor”). The initial value defined in the column 603 is set as this value. A “Resolution” tag 906 indicates that the scan resolution is 600 dpi×600 dpi (“600×600”). The initial value defined in the column 603 is set as this value as well. A “CopyRatio” tag 907 indicates that the magnification of the scanned image is 100% (“100”).

A “Send” tag 908 is setting information about the transmission job executed in this scripting process. Here, as shown in an “FTPAddress” tag 909, it indicates that the destination of transmission using the FTP protocol is a server “ftpserver.xxx.com”. A “FileFormat” tag 910 indicates that the format of the file to be transmitted is a PDF format, and a “FileName” tag 911 indicates that the name of the file to be transmitted is “20091217.pdf”.

In the case where the function information management unit 407 manages the function information 650, the script 950 shown in FIG. 7B is generated. Here, only the difference between FIG. 7B and FIG. 7A will be described. A “ColorMode” tag 951 indicates that the color mode is black and white mode (“BlackWhite”). The initial value defined in the column 653 is set as this value. A “Resolution” tag 952 indicates that the scan resolution is 200 dpi×200 dpi (“200×200”). The initial value defined in the column 653 is used as this value as well. A “FileFormat” tag 953 indicates that the format of the file to be transmitted is a signed PDF (“SignaturePDF”). The attribute “editable” indicates that the value of the tag 953 is prohibited from being modified (“false”). The modifiability information in the column 655 is set as this attribute value. In this regard, although a definition is described in the script 950 only if the modifiability information is “false” in this embodiment, the definition may also be described if the modifiability information is “true”, rather than being omitted.

A comparison between the script 900 in FIG. 7A and the script 950 in FIG. 7B shows that the “CopyRatio” tag, which indicates a magnification, is not contained in the script 950. Thus, the MFP 110 generates different scripts depending on its state (function information).

Referring back to FIG. 5, the Web browser 402 receives the script generated in S105 from the script generation unit 406 (S106). The Web browser 402 transmits, to the Web application 501 holding the content corresponding to the above-described URL, a request for a setting screen (second operation screen) for executing scan and FTP transmission, through an HTTP POST command (S107). The Web browser 402 includes the script generated in S105 in this request. Although the script is included in the POST command in this embodiment, the script may be included in the HTTP header of the GET command or the URL. The logic unit 503 of the Web application 501 parses the script 900 received in S107 and generates screen information about the setting screen based on the parsed result (S108).

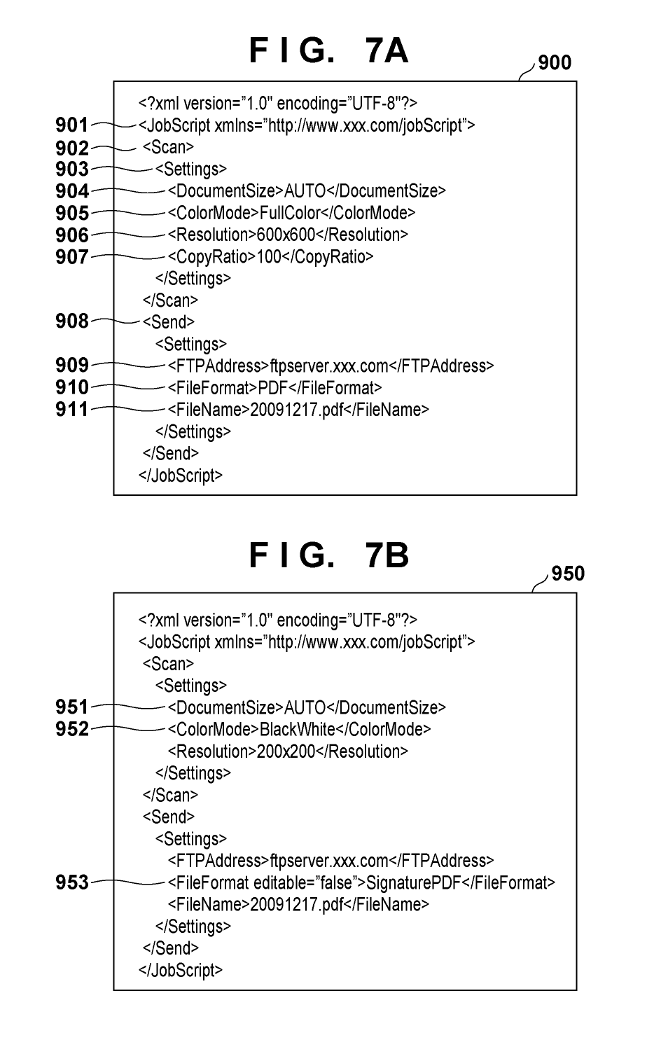

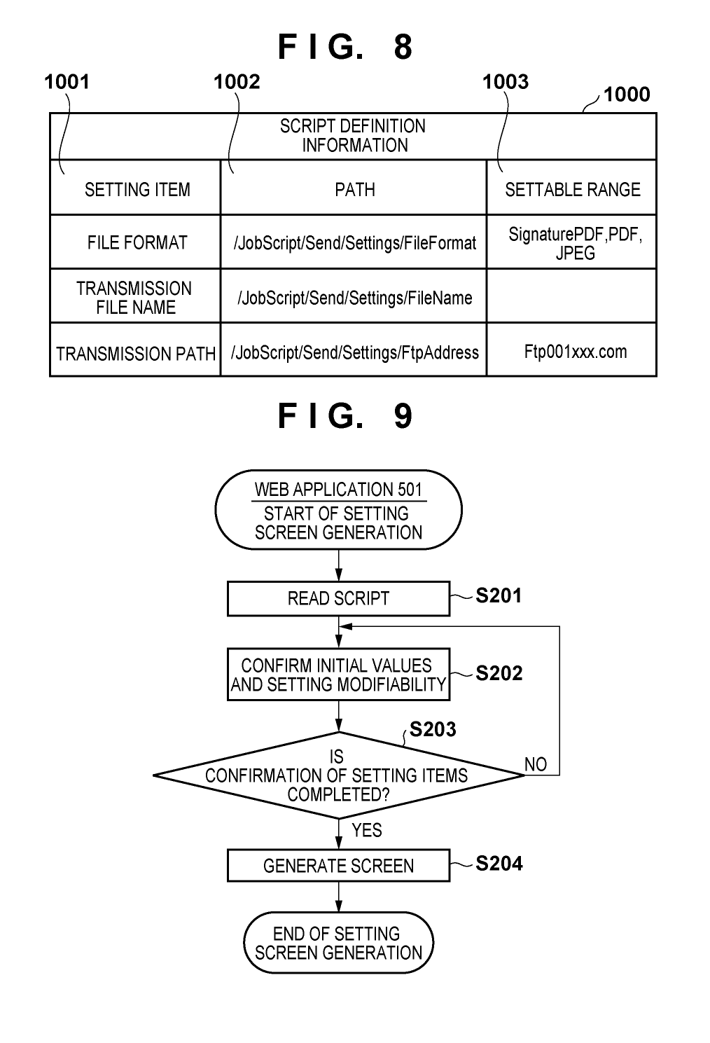

Here, the details of the operation executed by the Web application 501 in S108 will be described with reference to FIGS. 8 and 9. FIG. 8 shows an example of the script definition information managed by the logic unit 503 of the Web application 501. It is sufficient that script definition information 1000 contains the setting information of the MFP that is to be controlled by the Web application 501. In other words, the Web application 501 does not need to know all components of the script components. The script definition information 1000 may be in a CSV format or a text file described in XML or the like. A column 1001 indicates the setting items of the MFP 110. For example, referring to the first row, it can be seen that “file format” is indicated. A column 1002 indicates the path indicating the location where each setting item in the column 1001 is described in a script definition. For example, referring to the first row, it can be seen that the “file format” setting is described as the value of the “FileFormat” tag, which is contained in the “JobScript” tag, the “Send” tag and the “Settings” tag in this order. Although /(slash)-separated expressions are used as simple XPath (XML Path Language) expressions in this embodiment, the present invention is not limited thereto. It is possible to use any expressions as long as the location where each setting item is described in a script definition is clear. A column 1003 indicates the settable range of the setting items in the column 1001. For example, referring to the first row, it can be seen that the three types of formats “SignaturePDF” (signed PDF), “PDF” (PDF) and “JPEG” (JPEG) are settable as “file format”.

FIG. 9 is a flowchart illustrating the process by which the Web application 501 generates a setting screen in S108. First, the logic unit 503 reads the script 900 received in S107 (S201) and retrieves the initial values and the modifiability information that are described in the script 900 (S202). Here, the logic unit 503 retrieves the initial values and the modifiability information described in the script 900 for the setting items described in the script definition information 1000. Specifically, the logic unit 503 retrieves, from the paths described in the column 1002, the locations where the tags representing the setting items are described in the script, and checks if the retrieved tags have the “editable” attribute. Furthermore, the logic unit 503 acquires the values of the retrieved tags.

Next, the logic unit 503 determines whether the retrieval of the setting items described in the script definition information 1000 is completed (S203). If the retrieval is not completed, the logic unit 503 returns to S202 to retrieve the setting item in the next row of the script definition information 1000. If the retrieval is completed, the logic unit 503 moves to S204. In S204, the logic unit 503 generates the HTML data about the setting screen from the initial values and the modifiability information of the setting items that were retrieved in S202, thus finishing a series of the processes. The generated setting screen will be described later.

Referring back to FIG. 5 again, the Web application 501 transmits the HTML data about the setting screen generated in S108 to the Web browser 402 (S109). The Web browser 402 analyzes the received HTML data and displays the setting screen in the operation unit 111.

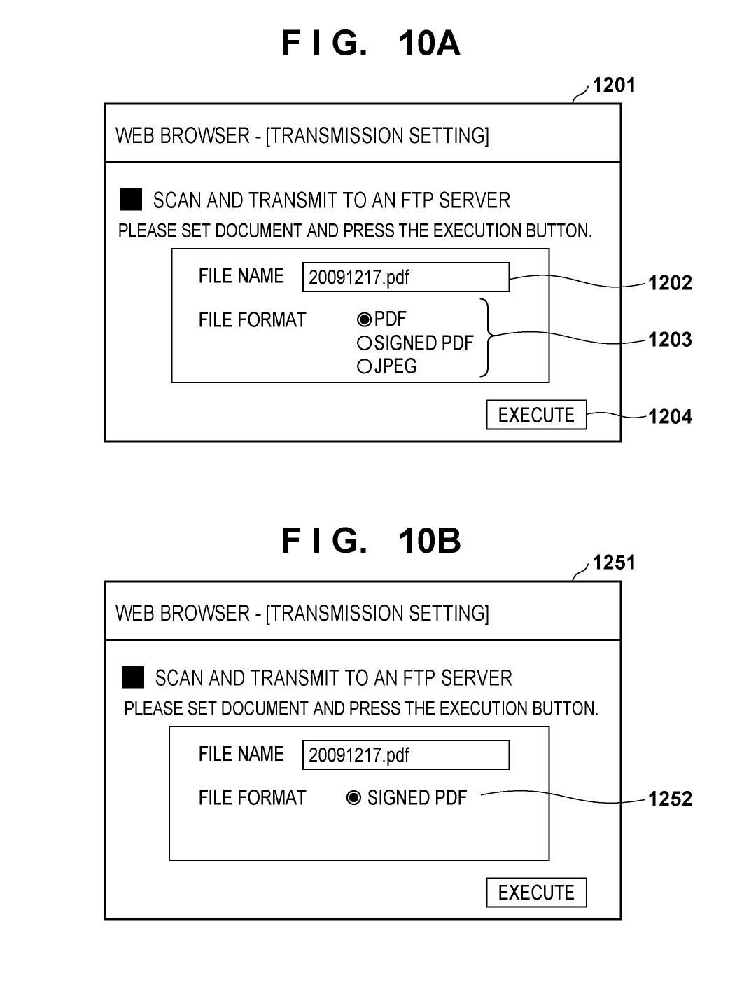

FIG. 10A shows an example of the setting screen displayed in the operation unit 111 by the Web browser 402. FIG. 10A shows a case where the script generated by the MFP 110 is the script 900 shown in FIG. 7A. A GUI panel 1201 includes a text box 1202 for setting a file name and radio buttons 1203 for selecting a file format. In FIG. 10A, settings have been established such that image data is provided with the file name “20091217.pdf” and that the image data is generated in a PDF format. The set values are the values described in the script 900. A GUI button 1204 is a button for instructing execution of the functions. The operation unit 111 transmits an instruction to the controller 200 to start scanning when the user depresses the GUI button 1204.

FIG. 10B shows another example of the setting screen displayed in the operation unit 111 by the Web browser 402. FIG. 10B shows a case where the script generated by the MFP 110 is the script 950 shown in FIG. 7B. Here, a description will be given only of the difference between FIG. 10B and FIG. 10A. In the script 950, the “editable” attribute exists as the attribute of the “FileFormat” tag and the value of the attribute is “false”. The initial value of the “FileFormat” tag is “SignaturePDF”. Accordingly, in S204, the logic unit 503 generates the setting screen such that the initial value of the file format is “signed PDF” and the user cannot modify the setting. The setting screen generated by the logic unit 503 is displayed in the operation unit 111 as the GUI panel 1251. That is, the item corresponding to the “FileFormat” tag is displayed in the GUI panel 1251 in a state where “signed PDF” is selected as indicated by a radio button 1252 and no other items can be selected. Thus, the modifiability information relating to the setting items is described in the script 950 that is transmitted from the Web browser 102 to the Web application 501, and therefore the Web application 501 can generate a setting screen corresponding to the state of the MFP.

Referring back to FIG. 5, when the GUI button 1204 is depressed by the user, the Web browser 402 notifies the Web application 501 of the parameters set in the text box 1202 and the radio buttons 1203 (S110). It is assumed that a POST command of the HTTP protocol is used for communication in S110. The Web application 501 edits the script by using the parameters received in S110 (S111). In other words, the Web application 501 edits the script in accordance with the result of the modification performed by the user via the setting screen.

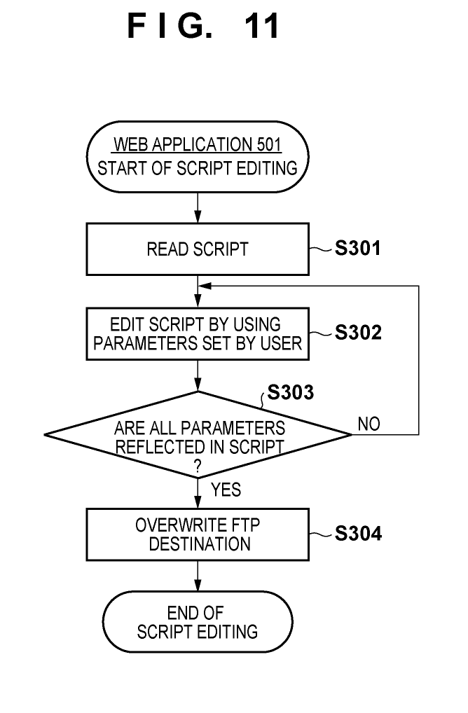

Here, the process by which the Web application 501 edits the script 900 shown in FIG. 7A in S111 will be described with reference to the flowchart shown in FIG. 11. The logic unit 503 reads the script 900 received in S107 (S301). Next, the logic unit 503 edits the script 900 by using the parameters received in S110 (S302). Specifically, the logic unit 503 retrieves, from the script 900, the tags corresponding to the setting items in the column 1001 described in the script definition information 1000 shown in FIG. 8. The logic unit 503 retrieves the locations where the tags indicating the setting items in the column 1001 are described in the script, with reference to the paths described in the column 1002 of the script definition information 1000. As the result of this retrieval, the logic unit 503 describes the parameters received in S110 as the values of the retrieved tags.

Next, the logic unit 503 determines whether the editing of the script 900 is completed for all the parameters received in S110 (S303). If the editing is not completed, the logic unit 503 returns to S302 to edit the setting item in the next row of the script definition information 1000. If the editing is completed, the logic unit 503 moves to S304. Thereafter, the logic unit 503 modifies the FTP server path (the value of the “FtpAddress” tag) in the script 900 (S304), thus finishing a series of the processes. Here, the value described in the column 1003 of the script definition information 1000 is described as the FTP server path.

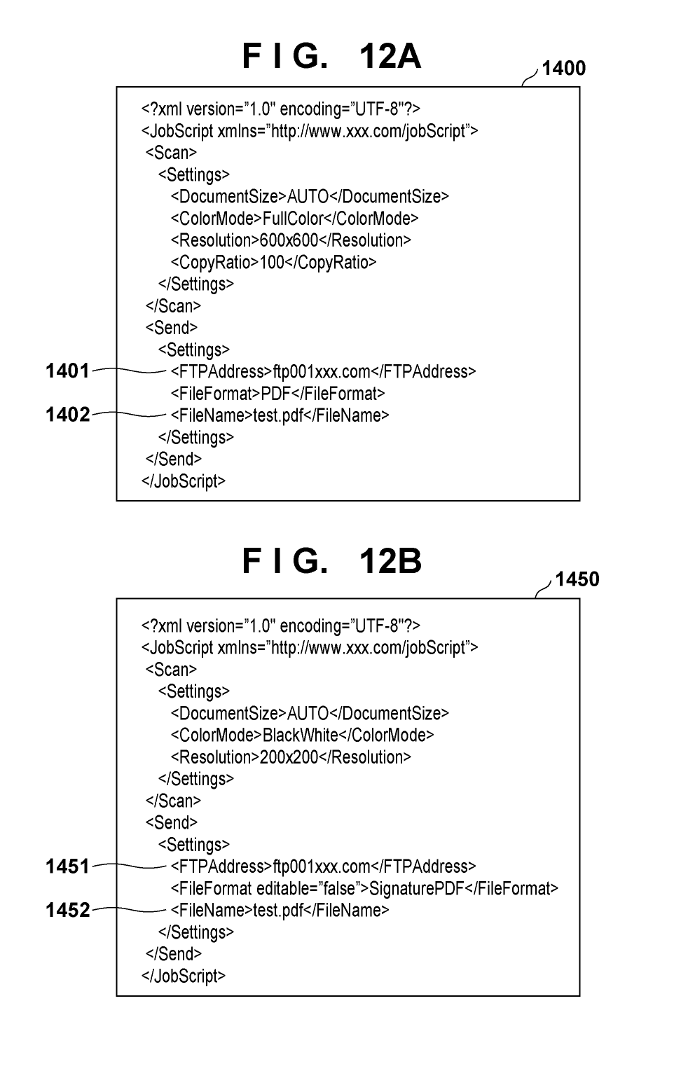

FIGS. 12A and 12B show examples of a script after editing the script 900 in S111. FIG. 12A shows a case where the user modifies the file name from “20091217.pdf” to “test.pdf” and maintains the file format as “PDF” in S110. In comparison with the script 900, the value of a tag 1401 indicating the FTP server path has been modified from “ftpserver.xxx.com” to “ftp001xxx.com”. This modification was made in S304. Further, the value of a tag 1402 indicating the name of the file to be transmitted has been modified from “20091217.pdf” to “test.pdf”. This corresponds to the modification made in S302 in which the description of the script 900 was modified to the parameter set by the user. Similarly, in FIG. 12B, the value of a tag 1451 indicating the FTP server path has been modified from “ftpserver.xxx.com” to “ftp001xxx.com”. The value of a tag 1452 indicating the name of the file to be transmitted has been modified from “20091217.pdf” to “test.pdf”. Thus, the Web application 501 does not need to know the content of a script other than the setting items that are to be controlled (in this embodiment, the FTP server path, the name of the file to be transmitted and the file format).

Referring back to FIG. 5, in S112, the Web application 501 transmits a script 1400 for which editing is completed to the Web browser. The Web browser 402 passes the script 1400 received in S112 to the script processing unit 403 (S113). The script processing unit 403 receives the script 1400 and executes the script.

As described above, according to this embodiment, the MFP generates a script according to its own state, and therefore the Web application does not need to know the content of the script other than the setting items that are to be controlled. Even if a script is enhanced due to, for example, a version upgrade of the MFP, it is not necessary to modify the Web application as long as no modification is made to the functions controlled by the Web application. Accordingly, it is possible to reduce the burden of development of a Web application.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-179001, filed Aug. 9, 2010, which is hereby incorporated by reference herein in its entirety.

What is claimed is:

1. An information processing apparatus comprising a Web browser that displays an operation screen based on screen information provided by a Web server, the apparatus comprising:
a generation unit that, if a user instructs execution of a function of the information processing apparatus via a first operation screen displayed in a display unit of the information processing apparatus by the Web browser, generates a script including a preset execution condition for executing the function;
a request unit that transmits the script generated by the generation unit to the Web server, and requests, from the Web server, screen information about a second operation screen for accepting a modification of the execution condition by the user;
a transmission unit that, upon acceptance of the modification of the execution condition by the user via the second operation screen displayed based on the screen information received from the Web server in response to the request made by the request unit, transmits the modified execution condition to the Web server; and
an execution unit that receives the script that has been edited by the Web server in accordance with the modified execution condition from the Web server, and executes the function in accordance with the edited script.

2. The information processing apparatus according to claim 1,
wherein the execution condition includes modifiability information indicating whether the execution condition can be modified by the user, and
the modifiability information is used when the second operation screen is generated in the Web server.

3. The information processing apparatus according to claim 1,
wherein the function of the information processing apparatus includes a scan function and a file transfer function by which a file containing image data that has been read by the scan function is transferred to the Web server, and
the execution condition for executing the scan function includes at least one of a color mode, a resolution and a magnification, and the execution condition for executing the file transfer function includes a format of the image data.

4. The information processing apparatus according to claim 1, wherein the generation unit is included in the Web browser.

5. An information processing system comprising a Web server and an information processing apparatus comprising a Web browser that displays an operation screen based on screen information provided by the Web server,
wherein the information processing apparatus comprises:
a generation unit that, if a user instructs execution of a function of the information processing apparatus via a first operation screen displayed in a display unit of the information processing apparatus by the Web browser, generates a script including a preset execution condition for executing the function;
a request unit that transmits the script generated by the generation unit to the Web server, and requests, from the Web server, screen information about a second operation screen for accepting a modification of the execution condition by the user;
a transmission unit that, upon acceptance of the modification of the execution condition by the user via the second operation screen displayed based on the screen information received from the Web server in response to the request made by the request unit, transmits the modified execution condition to the Web server; and
an execution unit that receives the script that has been edited by the Web server in accordance with the modified execution condition from the Web server, and executes the function in accordance with the edited script.

6. A control method for an information processing apparatus comprising a Web browser that displays an operation screen based on screen information provided by a Web server, the method comprising:
generating, if a user instructs execution of a function of the information processing apparatus via a first operation screen displayed in a display unit of the information processing apparatus by the Web browser, a script including a preset execution condition for executing the function;
transmitting the script generated in the generation step to the Web server, and requesting, from the Web server, screen information about a second operation screen for accepting a modification of the execution condition by the user;
transmitting, upon acceptance of the modification of the execution condition by the user via the second operation screen displayed based on the screen information received from the Web server in response to the request made in the request step, the modified execution condition to the Web server; and
receiving the script that has been edited by the Web server in accordance with the modified execution condition from the Web server, and executing the function in accordance with the edited script.

7. A computer-readable recording medium storing a program for causing a computer to, in an information processing apparatus comprising a Web browser that displays an operation screen based on screen information provided by a Web server, function as:
a generation unit that, if a user instructs execution of a function of the information processing apparatus via a first operation screen displayed in a display unit of the information processing apparatus by the Web browser, generates a script including a preset execution condition for executing the function;
a request unit that transmits the script generated by the generation unit to the Web server, and requests, from the Web server, screen information about a second operation screen for accepting a modification of the execution condition by the user;
a transmission unit that, upon acceptance of the modification of the execution condition by the user via the second operation screen displayed based on the screen information received from the Web server in response to the request made by the request unit, transmits the modified execution condition to the Web server; and
an execution unit that receives the script that has been edited by the Web server in accordance with the modified execution condition from the Web server, and executes the function in accordance with the edited script.
